(19) United States
(12) Patent Application Publication
(10) Pub. No.: US 2008/0284495 A1
(43) Pub. Date: Nov. 20, 2008

(54) MOS CAPACITOR WITH LARGE CONSTANT VALUE

(75) Inventors: Kuei-ti Chan, Hsin-Chu City (TW); Shou-tsung Wang, Sinying City (TW)

Correspondence Address: MADSON & AUSTIN, 15 WEST SOUTH TEMPLE, SUITE 900, SALT LAKE CITY, UT, 84101, US

(73) Assignee: MEDIATEK Inc., Hsin-Chu (TW)

(21) Appl. No.: 11/748,831

(22) Filed: May 15, 2007

(51) Int. Cl. G05F 3/02

(52) U.S. Cl. 327/535

(57) ABSTRACT

A capacitor circuit includes a first capacitor having a positive terminal coupled to a first node and a negative terminal coupled to a second node, a second capacitor having a negative terminal coupled to the first node and a positive terminal coupled to the second node, a third capacitor having a positive terminal coupled to the first node and a negative terminal coupled to a third node, a fourth capacitor having a negative terminal coupled to the first node, and a positive terminal coupled to the third node, a first voltage drop generator coupled between the second node and a fourth node for providing a first voltage drop between the second node and the fourth node, and a second voltage drop generator coupled between the fourth node and the third node for providing a second voltage drop between the fourth node and the third node.

### BACKGROUND OF THE INVENTION

1. Field of the Invention

The present invention relates to a capacitor, and more specifically, to a high density capacitor with linear capacitances.

2. Description of the Related Art

Many wireless communication applications, e.g. cellular phones, require both analog and digital signal processing, where mixed analog and digital signal processing is required on both the transmittal side and receiver side. Accordingly, mixed signal devices utilizing both analog and digital circuits for analog and digital signal processing, where a capacitor is one of the most important elements, and the voltage coefficient of capacitance is a key parameter to determine the operation performance of a capacitor.

Typically, the integration of a process suitable for manufacturing these capacitors with a conventional digital CMOS fabrication process would introduce additional cost and/or complexity into the fabrication process, or would result in capacitors that lack the desired linearity over a sufficient range of biasing conditions. Metal/metal capacitors, in which a pair of deposited metal layer separated by an interlevel dielectric form the capacitor, have also been investigated. The metal/metal capacitor is fully integrated into the backend of an existing fabrication process such that the existing metal and oxide deposition steps are used to produce the capacitor. Unfortunately, the use of existing metal structures in conjunction with the thick interlevel dielectrics characteristic of contemporary fabrication processes results in large area and typically imprecise capacitors. Other metal/metal capacitors have been proposed using tantalum (Ta) or tantalum nitride (TaN) plates, but Ta or TaN capacitors introduce multiple additional deposition and masking steps that increase the cost of the process. Therefore, it is highly desirable to implement a reliable and linear capacitor circuit that can be fabricated by an existing standard CMOS fabrication process without adding cost in the form of additional processing.

### SUMMARY OF THE INVENTION

It is therefore a primary objective of this invention to provide a capacitor circuit capable of providing a linearly varied capacitance and a constant capacitance over operating voltage.

Briefly summarized, the claimed invention provides a capacitor circuit comprises a first capacitor having a positive terminal coupled to a first node and a negative terminal coupled to a second node, a second capacitor comprising a negative terminal coupled to the first node and a positive terminal coupled to the second node, a third capacitor comprising a positive terminal coupled to the first node and a negative terminal coupled to a third node, a fourth capacitor comprising a negative terminal coupled to the first node, and a positive terminal coupled to the third node, a first voltage drop generator coupled between the second node and a fourth node for providing a first voltage drop between the second node and the fourth node, and a second voltage drop generator coupled between the fourth node and the third node for providing a second voltage drop between the fourth node and the third node.

In one aspect of the present invention, the capacitor circuit further comprises a fifth capacitor and a sixth capacitor. The fifth capacitor comprises a positive terminal coupled to the first node, and a negative terminal coupled to the fourth node. The sixth capacitor comprises a negative terminal coupled to the first node, and a positive terminal coupled to the fourth node.

In another aspect of the present invention, at least one of the first voltage drop generator and the second voltage drop generator is a diode, a resistor, a BJT transistor, or a MOS transistor.

In yet another aspect of the present invention, the capacitor circuit further comprises a first current source coupled between a first voltage source and the second node, and a second current source coupled between the third node and a second voltage source. The first current source generates a first current to control the first voltage drop while the second current source generates a second current to control the second voltage drop.

According to the claimed invention, a capacitor circuit comprises a first capacitor pair coupled between a first node and a second node, a second capacitor pair coupled between the first node and a third node, a third capacitor pair coupled between the first node and a fourth node, and a fourth capacitor pair coupled between the first node and a fifth node. Each capacitor pair comprises a first capacitor, a second capacitor, a first end, and a second end. The first capacitor comprises a positive terminal coupled to the first end and a negative terminal coupled to the second end. The second capacitor comprises a negative terminal coupled to the first end and a positive terminal coupled to the second end. Each capacitor pair is coupled to corresponding nodes via the first end and the second end. The capacitor also comprises a first voltage drop generator coupled between the third node and a sixth node, a second voltage drop generator coupled between the second node and the sixth node, a third voltage drop generator coupled between the sixth node and the fourth node, and a fourth voltage drop generator coupled between the sixth node and the fifth node. Each voltage drop generator comprises a first end and a second end, and provides a corresponding voltage drop between the first end and the second end. Each voltage drop generator is coupled to corresponding nodes via the first end and the second end.

In one aspect of the present invention, the capacitor circuit further comprises a fifth capacitor pair coupled between the first node and the sixth node. The fifth capacitor pair comprises a first capacitor and a second capacitor, the first capacitor comprises a positive terminal coupled to a first end and a negative terminal coupled to a second end, the second capacitor comprises a negative terminal coupled to the first end and a positive terminal coupled to the second end, and the fifth capacitor pair is coupled to the first node via the first end and coupled to the sixth node via the second end.

In another aspect of the present invention, at least one of the first, the second, the third, and the fourth voltage drop generators is a diode, a resistor, a BJT transistor, or a MOS transistor

In yet aspect of the present invention, the capacitor circuit further comprises a first current source coupled between a first voltage source and the third node, a second current source coupled between a second voltage source and the second node, a third current source coupled between a third voltage source and the fourth node, and a fourth current source coupled between a fourth voltage source and the fifth node. The first current source generates a first current to control the voltage drop between the first voltage source and the third node. The second current source generates a second current to control the voltage drop between the second voltage source and the second node. The third current source generates a third current to control the voltage drop between the third voltage source and the fourth node. The fourth current source generates a fourth current to control the voltage drop between the fourth voltage source and the fifth node.

According to the claimed invention, a capacitor circuit comprises a plurality of capacitor pairs, wherein each capacitor pair comprises a first capacitor, a second capacitor, a first end, and a second end. The first capacitor comprises a positive terminal coupled to the first end, and a negative terminal coupled to the second end. The second capacitor comprises a negative terminal coupled to the first end, and a positive terminal coupled to the second end. Each of the capacitor pairs is coupled to a first node via the first end of the capacitor pair. The capacitor also comprises a plurality of voltage drop generators, wherein each voltage drop generator is coupled between a second node and the second end of one of the capacitor pairs, and each voltage drop generator provides a corresponding voltage drop between the second node and the second end of the capacitor pair being coupled.

According to the claimed invention, a capacitor circuit comprises a plurality of capacitors and a plurality of voltage drop generators. Each capacitor comprises a first end and a second end, and each capacitor is coupled to a first node via the first end of the capacitor. Each voltage drop generator is coupled between a second node and the second end of one of the capacitors, and each voltage drop generator provides a corresponding voltage drop between the second node and the second end of the capacitor being coupled.

These and other objectives of the present invention will no doubt become obvious to those of ordinary skill in the art after reading the following detailed description of the preferred embodiment, which is illustrated in the various figures and drawings.

### BRIEF DESCRIPTION OF THE DRAWINGS

FIG. 1 shows a capacitor circuit in accordance with a first embodiment of the present invention.

FIG. 2 illustrates a relationship of a capacitance versus operating voltage.

FIGS. 3A-3C respectively show a single capacitor, a capacitor coupling with a voltage drop +ΔV, a capacitor coupling with a voltage drop −ΔV.

FIG. 4 shows a capacitor circuit in accordance with a second embodiment of the present invention.

FIG. 5 illustrates a relationship of a capacitance versus operating voltage.

FIGS. 6A-6C respectively show a single capacitor pair, a capacitor pair coupling with a voltage drop +ΔV, a capacitor pair coupling with a voltage drop −ΔV.

FIG. 7 shows a capacitor circuit in accordance with a third embodiment of the present invention.

FIG. 8 illustrates a relationship of capacitance over voltage for a various amount of current.

FIG. 9 shows a capacitor circuit in accordance with a fourth embodiment of the present invention.

### DETAILED DESCRIPTION OF THE PREFERRED EMBODIMENT

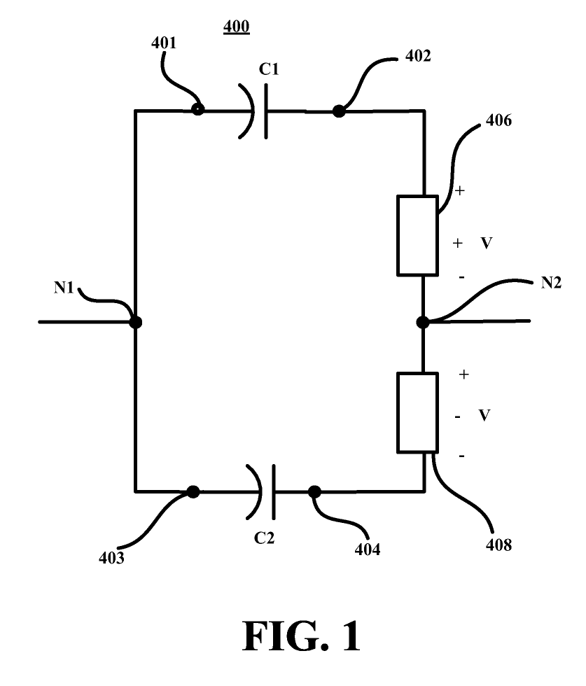

Please refer to FIG. 1 showing a capacitor circuit 400 in accordance with a first embodiment of the present invention. The capacitor circuit 400 comprises a plurality of capacitors C1, C2 and a plurality of voltage drop generators 406, 408. The capacitor C1 comprises a first end 401 and a second end 402, and the capacitor C2 comprises a third end 403 and a fourth end 404. The capacitor C1 is coupled to a first node N1 via the first end 401 of the capacitor C1, and the capacitor C2 is coupled to the first node N1 via the third end 403. The voltage drop generator 406 is coupled between a second node N2 and the second end 402 of the capacitors C1, while the voltage drop generator 408 is coupled between the second node N2 and the fourth end 404 of the capacitors C2.

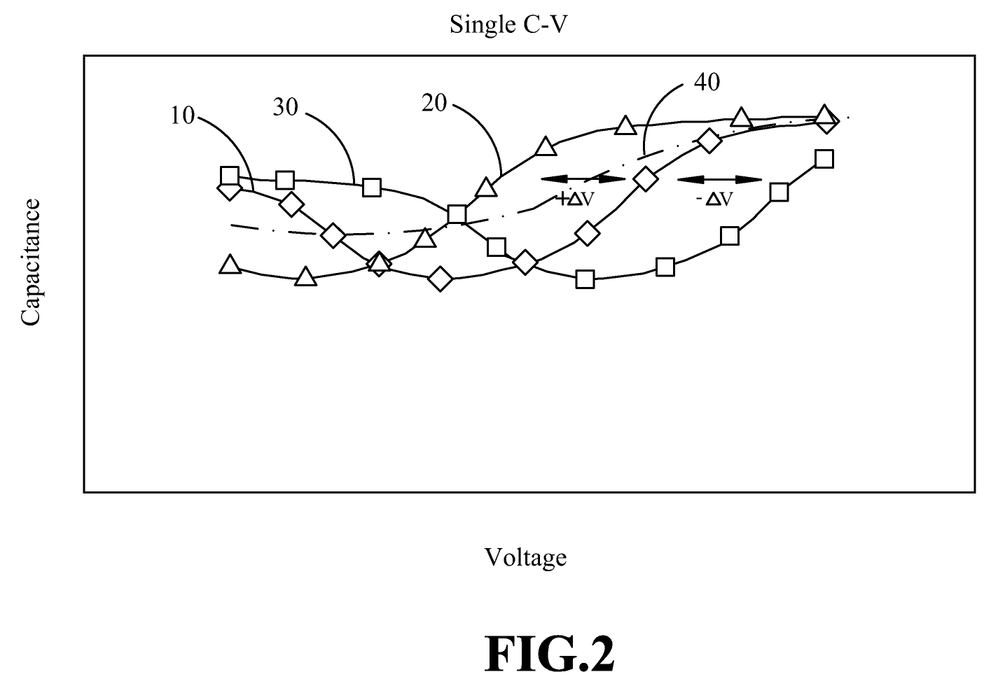

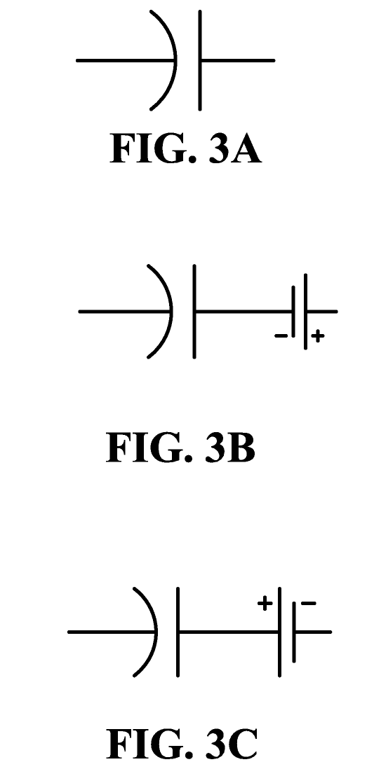

FIG. 2 illustrates a relationship of a capacitance versus operating voltage. A C-V curve 10 indicates a capacitance variation of a single capacitor shown in FIG. 3A over operating voltage. A C-V curve 20 indicates a capacitance variation of a capacitor coupling with a voltage drop +ΔV, as shown in FIG. 3B, over operating voltage V. A C-V curve 30 indicates a capacitance variation of a capacitor coupling with a voltage drop −ΔV shown in FIG. 3C over operating voltage V. When the capacitor C1 together with the voltage drop +ΔV is coupled in parallel with the capacitor C2 together with the voltage drop −ΔV, thereby forming the capacitor circuit 400 as shown in FIG. 1, the capacitance of the capacitor circuit 400 is a sum of the two capacitances of the capacitors C1, C2, and its C-V curve 40 shown in FIG. 2 indicates a more approximate linearity than C-V curve 10 associated with a single capacitor shown in FIG. 3A. In this manner, the capacitor circuit 400 provides a more linearly varied capacitance over operating voltage, as is convenient for a designer to set the desired capacitance during design cycle.

Preferably, the voltage drop generators 406, 408 provide a corresponding voltage drop ±ΔV, so either of the voltage drop generators 406, 408 may be implemented by a resistor, a BJT transistor of which a base is coupled to a collector (or an emitter) of the BJT transistor, a MOS transistor of which a gate is coupled to a drain of the MOS transistor, or a MOS transistor of which a gate is coupled to a source of the MOS transistor.

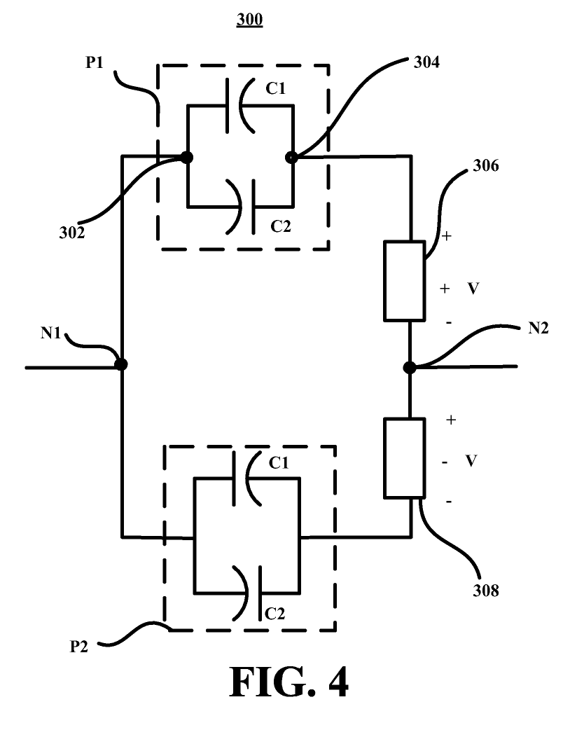

Please refer to FIG. 4 showing a capacitor circuit 300 in accordance with a second embodiment of the present invention. The capacitor circuit 300 comprises a plurality of capacitor pairs P1, P2 and a plurality of voltage drop generators 306, 308. Each capacitor pair P1, P2 comprises a first capacitor C1, a second capacitor C2, a first end 302, and a second end 304. The first capacitor C1 comprises a positive terminal coupled to the first end 302 and a negative terminal coupled to the second end 304, while the second capacitor C2 comprises a negative terminal coupled to the first end 302 and a positive terminal coupled to the second end 304. Each of the capacitor pairs P1, P2 is coupled to a first node N1 via the first end 302. Each of the voltage drop generators 306, 308 is coupled between a second node N2 and the second end 304.

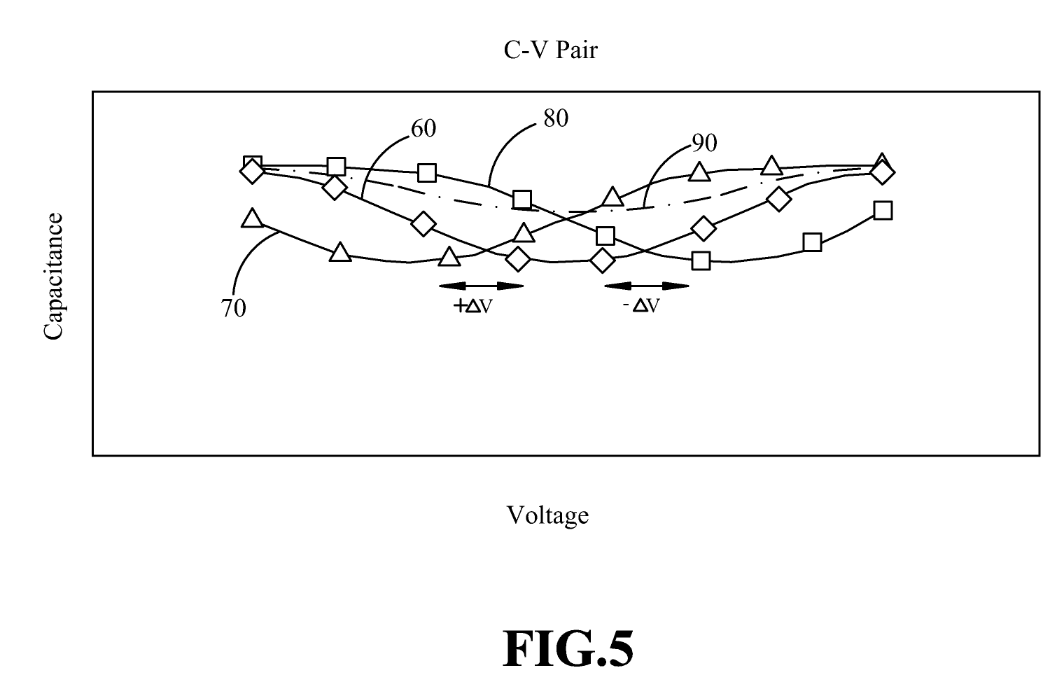

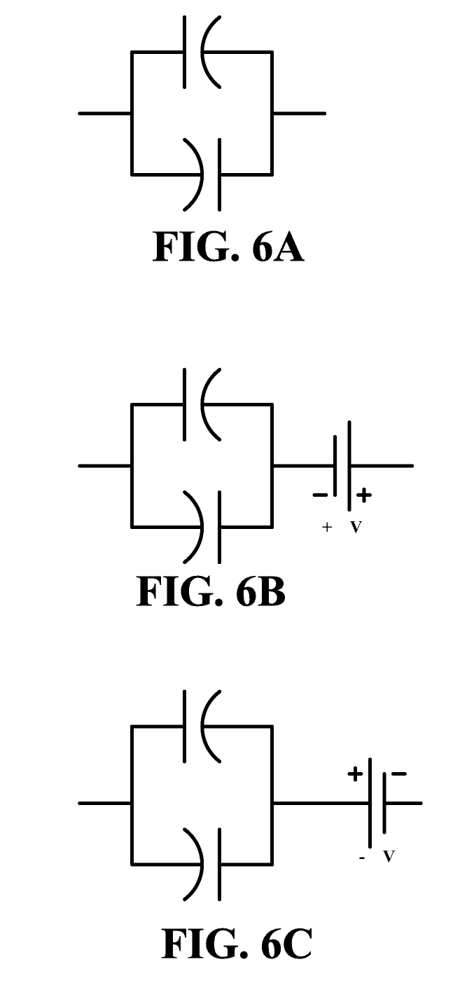

Please refer to FIG. 5 and FIGS. 6A-6C. FIG. 5 illustrates a relationship of a capacitance versus operating voltage. A C-V curve 60 indicates a capacitance variation of a single capacitor pair shown in FIG. 6A over operating voltage. A C-V curve 70 indicates a capacitance variation of a capacitor pair coupling with a voltage drop +ΔV, as shown in FIG. 6B, over operating voltage V. A C-V curve 80 indicates a capacitance variation of a capacitor pair P2 coupling with a voltage drop −ΔV, as shown in FIG. 6C, over operating voltage V When capacitor pair P1 together with the voltage drop +ΔV is coupled in parallel with capacitor pair P2 together with the voltage drop −ΔV, thereby forming the capacitor circuit 300 as shown in FIG. 4, the overall capacitance of the capacitor circuit 300 is achieved by summing the individual capacitance of the capacitor pairs P1, P2. The C-V curve 90 of the capacitor circuit 300 shown in FIG. 5 indicating a capacitance variation over operating voltage is more approximately close to a constant value than that of a single capacitor pair indicative of the C-V curve 60. In this manner, the capacitor circuit 300 provides a more approximate constant capacitance over the range of operating voltages, especially around zero-bias voltage, as is convenient for a designer to set the desired capacitance during design cycle.

The voltage drop generators 306, 308 provide a first voltage drop +ΔV and a second voltage drop −ΔV between the second node N2 and the second end 304, so either of the voltage drop generators 306, 308 may be implemented by a resistor, a BJT transistor of which a base is coupled to a collector (or an emitter)of the BJT transistor, a MOS transistor of which a gate is coupled to a drain of the MOS transistor, or a MOS transistor of which a gate is coupled to a source of the MOS transistor.

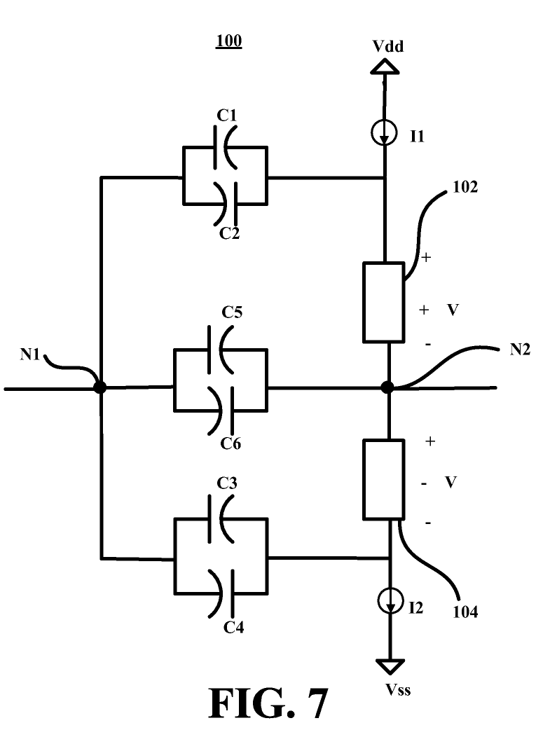

Please refer to FIG. 7 showing a capacitor circuit 100 in accordance with a third embodiment of the present invention. The capacitor circuit 100 is similar to that shown in FIG. 4 except that a third capacitor pair P3 is added. The capacitor pair P3 includes two capacitors C5 and C6. A positive terminal of C5 is coupled to a negative terminal of C6 and a negative terminal of C5 is coupled to a positive terminal of C6.

In this embodiment, a first current source I1 is used to control the first voltage drop of the first voltage drop generator 102. A second current source I2 is used to control the second voltage drop of the second voltage drop generator 104. In other embodiments, voltage sources can be used to replace the current sources.

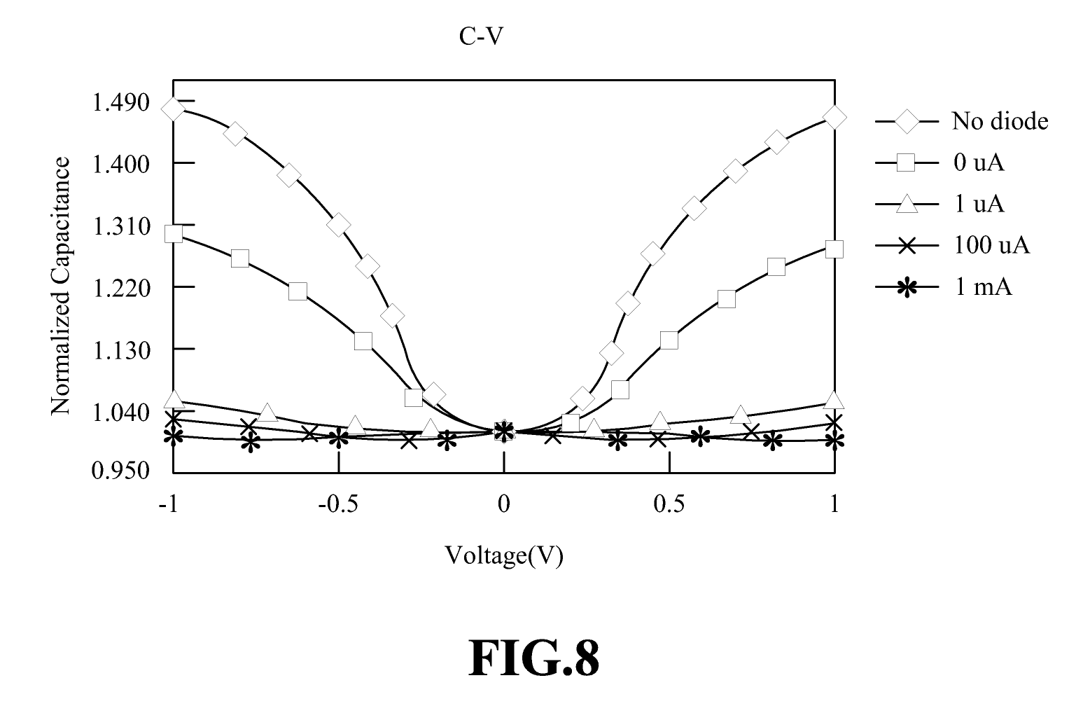

Similar to relationships depicted in FIG. 5, the capacitor circuit 100 provides a capacitance more approximately close to a constant value over operating voltage than that of the capacitor circuit 300. In addition, with reference to FIG. 8 illustrating a relationship of capacitance over voltage for a various amount of current flowing through the voltage drop generators 102, 104, a larger amount of current flowing through the voltage drop generators 102, 104, a capacitance more close to a constant value is obtained. In other words, because the curve variation of the C-V curve associated with the capacitor circuit 100 is changed as the first voltage drop +ΔV and the second voltage −ΔV, a proper adjustment of the first current and the second current flowing through the first voltage drop generator 102 and the second voltage drop generator 104 causes changes of the first voltage drop +ΔV and the second voltage −ΔV as well as a flatter C-V curve associated with the capacitor circuit 300.

The voltage drop generators 102, 104 provide a corresponding voltage drop ±ΔV between the second node N2 and the fourth node N4, and between the third node N3 and the fourth node N4, so either of the voltage drop generators 102, 104 may be implemented by a resistor, a diode, a BJT transistor of which a base is coupled to a collector (or an emitter)of the BJT transistor, a MOS transistor of which a gate is coupled to a drain of the MOS transistor, or a MOS transistor of which a gate is coupled to a source of the MOS transistor.

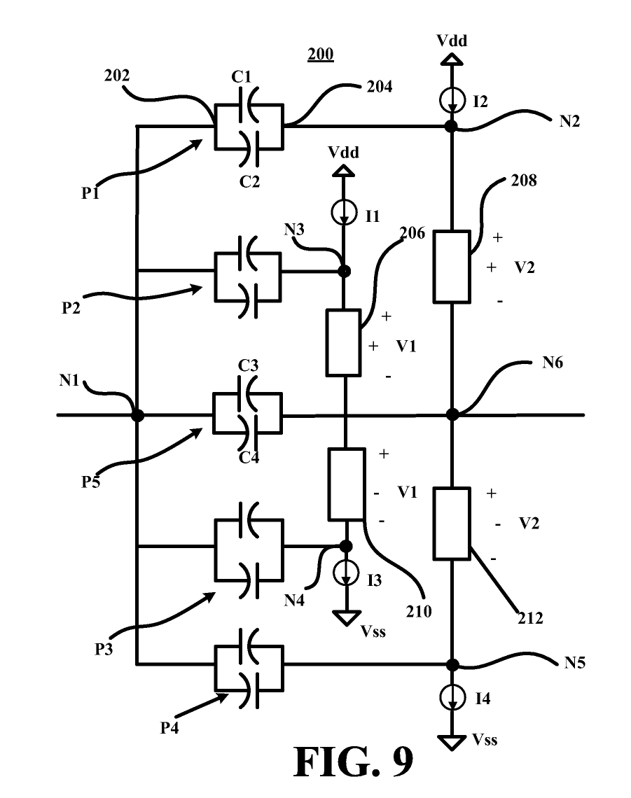

Please refer to FIG. 9 showing a capacitor circuit 200 in accordance with the fourth embodiment of the present invention. A capacitance pair P1 is coupled to a voltage drop generator 208. The voltage drop generator 208 provides a voltage dropΔV2 in this embodiment. A current source I2 is used to control the voltage drop ΔV2. Capacitor pairs P2, P3, and P4 are implemented by similar way. A capacitor pair P5 is placed at the center of the capacitor circuit 200 and is coupled to node N1 and N6. All current sources I1, I2, I3, and I4 operate to control voltage drops of their respective paths. In another embodiment, the use of voltage generators for generating constant voltage is allowed to replace the current sources I1, I2, I3, and I4. The capacitors shown in the above embodiments (FIG. 1, FIG. 4, FIG. 7 and FIG. 9) are preferably n⁺ in n-well MOS capacitors.

Similar to relationships depicted in FIG. 5, the capacitor circuit 200 provides a capacitance more approximately constant to a constant value over operating voltage than that of the capacitor circuit 300. In addition, with reference to FIG. 10 illustrating a relationship of capacitance over voltage for a various amount of current flowing through the voltage drop generators 206, 208, 210, 212, a larger amount of current flowing through the voltage drop generators 206, 208, 210, 212, a flatter slope of the change in capacitance as a function of a change in voltage associated with the capacitor circuit 200 is obtained. In other words, because the curve variation of the C-V curve associated with the capacitor circuit 200 is changed as the voltage drops ±ΔV1, ±ΔV2, an proper adjustment of the current flowing through the first voltage drop generators 206, 208, 210, 212 causes changes of the voltage drops ±ΔV1, ±ΔV2, as well as a flat C-V curve associated with the capacitor circuit 200.

While the depicted embodiment of capacitor circuit 200 shown in FIG. 9 includes five capacitor pairs and four voltage drop generators, it is appreciated that additional capacitor pairs and voltage drop generators may be added to provide further control over the linearity characteristics of capacitor circuit 200. In one embodiment, the voltage drop generators 206, 208, 210, 212 may include one or more resistors, or diodes for generating voltage drop 2×ΔV1, 2×ΔV2 or more. Such configuration may obtain flatter slope of C-V curve associated with the capacitor circuit.

In contrast to prior art, without using special MOS process to fabricate special capacitors, the present invention using any conventional MOS processes provides a capacitor circuit having one or more capacitor pairs and voltage drop generators for providing voltage shifts to compensate a severe slope of a change in capacitance versus a range of operating voltages. The linearity of capacitor circuit may then be optimized by varying the mount of voltage drops of the voltage drop generators. In this manner, the invention provides the ability to optimize the linearity of the capacitor circuit over a wide range of voltages. Additionally, the overall capacitance of the capacitor circuit is achieved by summing the individual capacitances of the capacitor circuit. Consequently, high density linear capacitors are obtained.

Although the present invention has been explained by the embodiments shown in the drawings described above, it should be understood to the ordinary skilled person in the art that the invention is not limited to the embodiments, but rather various changes or modifications thereof are possible without departing from the spirit of the invention. Accordingly, the scope of the invention shall be determined only by the appended claims and their equivalents.

What is claimed is:

1. A capacitor circuit, comprising:
a first capacitor comprising a positive terminal coupled to a first node, and a negative terminal coupled to a second node;
a second capacitor comprising a negative terminal coupled to the first node, and a positive terminal coupled to the second node;
a third capacitor comprising a positive terminal coupled to the first node, and a negative terminal coupled to a third node;
a fourth capacitor comprising a negative terminal coupled to the first node, and a positive terminal coupled to the third node;
a first voltage drop generator coupled between the second node and a fourth node, the first voltage drop generator providing a first voltage drop between the second node and the fourth node; and
a second voltage drop generator coupled between the fourth node and the third node, the second voltage drop generator providing a second voltage drop between the fourth node and the third node.

2. The capacitor circuit of claim 1, further comprising:
a fifth capacitor comprising a positive terminal coupled to the first node, and a negative terminal coupled to the fourth node; and
a sixth capacitor comprising a negative terminal coupled to the first node, and a positive terminal coupled to the fourth node.

3. The capacitor circuit of claim 1, wherein at least one of the first voltage drop generator and the second voltage drop generator is a diode.

4. The capacitor circuit of claim 1, wherein at least one of the voltage drop generators comprises a BJT transistor, and a base of the BJT transistor is coupled to a collector of the BJT transistor.

5. The capacitor circuit of claim 1, wherein at least one of the voltage drop generators comprises a BJT transistor, and a base of the BJT transistor is coupled to an emitter of the BJT transistor.

6. The capacitor circuit of claim 1, wherein the capacitors are n⁺ in n-well MOS capacitors.

7. The capacitor circuit of claim 1, wherein at least one of the voltage drop generators comprises a MOS transistor, and a gate of the MOS transistor is coupled to a source of the MOS transistor.

8. The capacitor circuit of claim 1, wherein at least one of the voltage drop generator comprises a MOS transistor, and a gate of the MOS transistor is coupled to a drain of the MOS transistor.

9. The capacitor circuit of claim 1, wherein at least one of the first voltage drop generator and the second voltage drop generator is a resistor.

10. The capacitor circuit of claim 1, further comprising: a first current source coupled between a first voltage source and the second node, the first current source generating a first current to control the first voltage drop; and
a second current source coupled between the third node and a second voltage source, the second current source generating a second current to control the second voltage drop.

11. The capacitor circuit of claim 1, wherein the second node is coupled to a first voltage source, and the third node is coupled to a second voltage source.

12. A capacitor circuit, comprising:
a first capacitor pair, a second capacitor pair, a third capacitor pair, and a fourth capacitor pair coupled between a first node and a second node, between the first node and a third node, between the first node and a fourth node, and between the first node and a fifth node respectively, wherein each capacitor pair comprises a first capacitor, a second capacitor, a first end, and a second end, and the first capacitor comprises a positive terminal coupled to the first end and a negative terminal coupled to the second end, the second capacitor comprises a negative terminal coupled to the first end and a positive terminal coupled to the second end, and each capacitor pair is coupled to corresponding nodes via the first end and the second end; and
a first voltage drop generator, a second voltage drop generator, a third voltage drop generator, and a fourth voltage drop generator coupled between the third node and a sixth node, between the second node and the sixth node, between the sixth node and the fourth node, and between the sixth node and the fifth node respectively, wherein each voltage drop generator comprises a first end and a second end, each voltage drop generator provides a corresponding voltage drop between the first end and the second end, and each voltage drop generator is coupled to corresponding nodes via the first end and the second end.

13. The capacitor circuit of claim 12, further comprising:
a fifth capacitor pair coupled between the first node and the sixth node, wherein the fifth capacitor pair comprises a first capacitor and a second capacitor, the first capacitor comprises a positive terminal coupled to a first end and a negative terminal coupled to a second end, the second capacitor comprises a negative terminal coupled to the first end and a positive terminal coupled to the second end, and the fifth capacitor pair is coupled to the first node via the first end and coupled to the sixth node via the second end.

14. The capacitor circuit of claim 12, wherein at least one of the first, the second, the third, and the fourth voltage drop generators is a diode.

15. The capacitor circuit of claim 12, wherein at least one of the first, the second, the third, and the fourth voltage drop generators is a BJT transistor, and a base of the BJT transistor is coupled to a collector of the BJT transistor.

16. The capacitor circuit of claim 12, wherein at least one of the first, the second, the third, and the fourth voltage drop generators is a BJT transistor, and a base of the BJT transistor is coupled to an emitter of the BJT transistor.

17. The capacitor circuit of claim 12, wherein the capacitors are n⁺ in n-well MOS capacitors.

18. The capacitor circuit of claim 12, wherein at least one of the first, the second, the third, and the fourth voltage drop generators comprises a MOS transistor, and a gate of the MOS transistor is coupled to a source of the MOS transistor.

19. The capacitor circuit of claim 12, wherein at least one of the first, the second, the third, and the fourth voltage drop generators comprises a MOS transistor, and a gate of the MOS transistor is coupled to a drain of the MOS transistor.

20. The capacitor circuit of claim 12, wherein at least one of the first, the second, the third, and the forth voltage drop generators is a resistor.

21. The capacitor circuit of claim 12, further comprising:
a first current source coupled between a first voltage source and the third node, the first current source generating a first current to control the voltage drop between the first voltage source and the third node;
a second current source coupled between a second voltage source and the second node, the second current source generating a second current to control the voltage drop between the second voltage source and the second node;
a third current source coupled between a third voltage source and the fourth node, the third current source generating a third current to control the voltage drop between the third voltage source and the fourth node; and
a fourth current source coupled between a fourth voltage source and the fifth node, the fourth current source generating a fourth current to control the voltage drop between the fourth voltage source and the fifth node.

22. The capacitor circuit of claim 12, wherein the third node is coupled to a first voltage source, the second node is coupled to a second voltage source, the fourth node is coupled to a third voltage source, and the fifth node is coupled to a fourth voltage source.

23. A capacitor circuit, comprising:
a plurality of capacitor pairs, wherein each capacitor pair comprises a first capacitor, a second capacitor, a first end, and a second end, the first capacitor comprises a positive terminal coupled to the first end, and a negative terminal coupled to the second end, the second capacitor comprises a negative terminal coupled to the first end, and a positive terminal coupled to the second end, each of the capacitor pairs is coupled to a first node via the first end of the capacitor pair; and
a plurality of voltage drop generators, wherein each voltage drop generator is coupled between a second node and the second end of one of the capacitor pairs, and each voltage drop generator provides a corresponding voltage drop between the second node and the second end of the capacitor pair being coupled.
